(19) United States
(12) Patent Application Publication
(10) Pub. No.: US 2022/0066427 A1
(43) Pub. Date: Mar. 3, 2022

(54) SYSTEM AND METHOD FOR DISTRIBUTING EDGE PROGRAM IN MANUFACTURING FIELD

(71) Applicant: Hitachi, Ltd., Tokyo (JP)

(72) Inventor: Yoshiho SEO, San Jose, CA (US)

(73) Assignee: Hitachi, Ltd.

(21) Appl. No.: 17/007,556

(22) Filed: Aug. 31, 2020

(51) Int. Cl. G05B 19/418; G06F 8/61; G05B 19/05

(52) U.S. Cl. CPC G05B 19/41835; G06F 8/61; G16Y 40/40; G05B 2219/31001; G05B 2219/1204; G05B 19/052

(57) ABSTRACT

Example implementations described herein are directed to systems and methods for deploying function packages onto machines connected to an Internet of Things (IoT) network. The function packages can include updates for machine functions or sensor functions, and can be triggered for deployment while the factory floor is running. Through the example implementations described herein, appropriate function packages can be scheduled and deployed to corresponding machines or sensors in response to an event occurring on the factory floor.

### BACKGROUND

### Field

The present disclosure is generally directed to manufacturing systems, and more specifically, to distributing edge programs in manufacturing fields.

### Related Art

In related art implementations, there are service platforms for analyzing data collected from devices such as sensors to provide a value-added solution. Such systems have emerged as a result of development of the Internet of Things (IoT) technology.

Factories are known as an example of an application target for IoT implementations. When IoT implementations are applied to a factory, sensor data is collected from sensors mounted to production machines and workers in the factory, and states and efficiencies of a production process of the factory are visualized and analyzed, to thereby detect abnormalities occurring in production sites, improve production plans and the production process, and increase production techniques of the workers.

As a specific example of the solution of applying the IoT to a factory, there is a related art solution involving analyzing sensor data collected from machines of the factory and configuration data on a production line with each other, to thereby analyze states and efficiencies of production lines of the factory.

### SUMMARY

To create a primary analysis program for sensor data, it can be necessary to consider machine characteristics and product characteristics. Further, as the diversification of products progresses, the burden of such making primary analysis program is also increasing. Example implementations described herein are directed to system and methods for organizing, storing, and efficiently using such primary processing based on past experience.

In the related art, there is considerable difficulty in deploying function packages to edge/IoT devices as they are monitoring physical machines. In example implementations described herein, the operational technology knowledge is linked with informational technology through using a data repository with asset database.

Aspects of the present disclosure can involve a method for a factory system including a plurality of assets, the plurality of assets including a plurality of programmable logic controllers (PLCs), a plurality of machines managed by the plurality of PLCs, and a plurality of sensors associated with the plurality of machines, the method involving extracting, from process information received from the factory system, a line identifier, a process identifier, and a location identifier, to select a target asset from the plurality of assets corresponding to the line identifier, the process identifier, and the location identifier, from an asset database managing the plurality of assets; determining, from event information received from the system, one or more events associated with the target asset; selecting a function method to be deployed to the target asset based on an event of the one or more events; and installing, for the target asset, a function package software corresponding to the target asset and the function method.

Aspects of the present disclosure can involve a non-transitory computer readable medium, storing instructions for a factory system including a plurality of assets, the plurality of assets including a plurality of programmable logic controllers (PLCs), a plurality of machines managed by the plurality of PLCs, and a plurality of sensors associated with the plurality of machines, the instructions including extracting, from process information received from the factory system, a line identifier, a process identifier, and a location identifier, to select a target asset from the plurality of assets corresponding to the line identifier, the process identifier, and the location identifier, from an asset database managing the plurality of assets; determining, from event information received from the system, one or more events associated with the target asset; selecting a function method to be deployed to the target asset based on an event of the one or more events; and installing, for the target asset, a function package software corresponding to the target asset and the function method.

Aspects of the present disclosure can involve a system for a factory system including a plurality of assets, the plurality of assets including a plurality of programmable logic controllers (PLCs), a plurality of machines managed by the plurality of PLCs, and a plurality of sensors associated with the plurality of machines, the system involving means for extracting, from process information received from the factory system, a line identifier, a process identifier, and a location identifier, to select a target asset from the plurality of assets corresponding to the line identifier, the process identifier, and the location identifier, from an asset database managing the plurality of assets; means for determining, from event information received from the system, one or more events associated with the target asset; means for selecting a function method to be deployed to the target asset based on an event of the one or more events; and means for installing, for the target asset, a function package software corresponding to the target asset and the function method.

Aspects of the present disclosure can involve an apparatus, configured to manage a factory system comprising a plurality of assets, the plurality of assets involving a plurality of programmable logic controllers (PLCs), a plurality of machines managed by the plurality of PLCs, and a plurality of sensors associated with the plurality of machines, the apparatus including a processor, configured to extract, from process information received from the factory system, a line identifier, a process identifier, and a location identifier, to select a target asset from the plurality of assets corresponding to the line identifier, the process identifier, and the location identifier, from an asset database managing the plurality of assets; determine, from event information received from the system, one or more events associated with the target asset; select a function method to be deployed to the target asset based on an event of the one or more events; and install, for the target asset, a function package software corresponding to the target asset and the function method.

### BRIEF DESCRIPTION OF DRAWINGS

FIG. 1 illustrates a system diagram of an example function distribution system in accordance with an example implementation.

FIG. 2 illustrates an example of the overall configuration of a system, in accordance with an example implementation.

FIGS. 3(a) to 3(d) illustrate variations of locations where the generated function package software is installed, in accordance with an example implementation.

FIG. 4 illustrates an example identification process, in accordance with an example implementation.

FIG. 5 illustrates an example of function package information in accordance with an example implementation.

FIG. 6 is an explanatory table for showing an example of the function rule, in accordance with an example implementation.

FIG. 7 is an explanatory table for showing an example of the asset configuration, in accordance with an example implementation.

FIG. 8 illustrates an example of the flowchart of the system, in accordance with an example implementation.

FIG. 9 illustrates an example of a block diagram for adjusting the distribution timing of a program, in accordance with an example implementation.

FIG. 10 illustrates an example of a block diagram for adjusting the distribution timing of a program, in accordance with an example implementation.

FIG. 11 illustrates an example of logging system for function distributor system, in accordance with an example implementation.

FIG. 12 illustrates an example of the processing flow when data of a target device or a target event does not exist in the function rule, in accordance with an example implementation.

FIG. 13 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

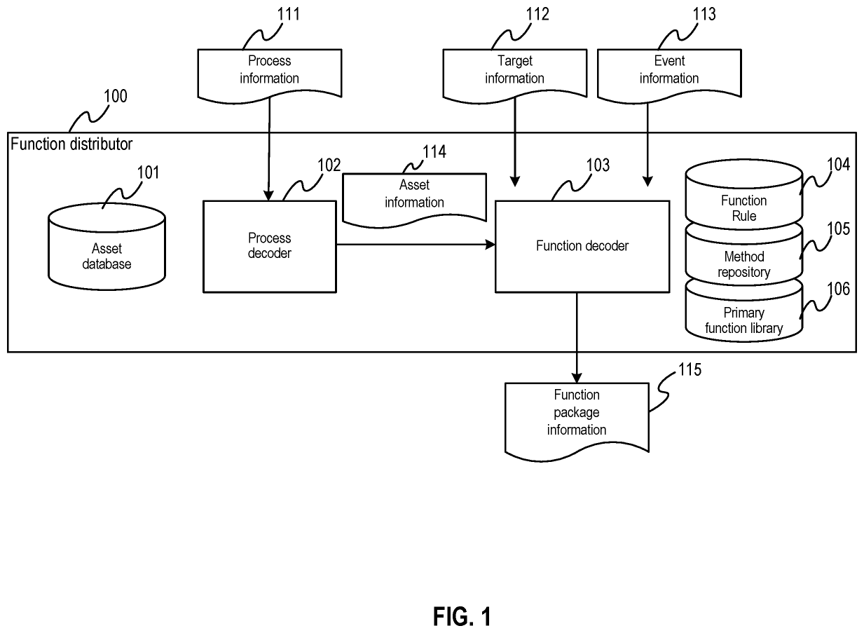

FIG. 1 illustrates a system diagram of an example function distribution system in accordance with an example implementation. The function distributor 100 receives process information 111, target information 112, and event information 113 as inputs, has an asset database 101, a process decoder 102, a function decoder 103, function rule 104 and a method repository 105, and has function package information 115 as an output.

The process information 111 involves information such as a manufacturing line number and a process name. Process decoder 102 uses process information 111 and the asset database 101 to generate target asset information 112. The target information 112 is the target of the analysis and indicates what is to be monitored, such as a manufacturing device or a product name. The event information 113 is information to be obtained regarding an event, such as the name of the error or the name of a characteristic behavior (e.g., detected vibration, stop, etc.).

The asset database 101 is configured to manage the relationship the above-described abstracted process information and the configuration of specific device names, functions, output types, and so on. The function rule 104 is configured to manage the relationship between event information, a target device, a target product and a method of calculation which stored in in the method repository 105. The method repository 105 stores methods of combining basic functions, and a value to be set for each basic function.

The process information 111 is input to the process decoder 102 and the process decoder 102 converts the process information 111 to asset information 114 by using asset database 101. Then the asset information 114 is input to function decoder 103.

The function decoder 103 selects the method of combining basic functions and setting the value of each function from the method repository by using function rule 104 as a database, and asset information 114, target information 112 and event information 113 as a key. Additionally, the function decoder 103 packs the method and setting value as package and outputs as function package information 115.

Asset information 114 contains the name of the specific equipment for the asset. Specifically, the name of the specific equipment for the asset is used as key for the searching function rule. Depending on the desired implementation information on vendors, functions, and affiliated devices may be included.

Primary function library 106 is a library of general arithmetic function provided as OSS or processing functions created by users. These are also able to include the compiler or interpreter.

Event information 113 contains the name of the target event, which is used as key for searching function rule 104.

In the example implementations described herein, the function decoder 103 selects the function package 115 (e.g., what process to invoke) from asset information 114, event information 113, and target information 112.

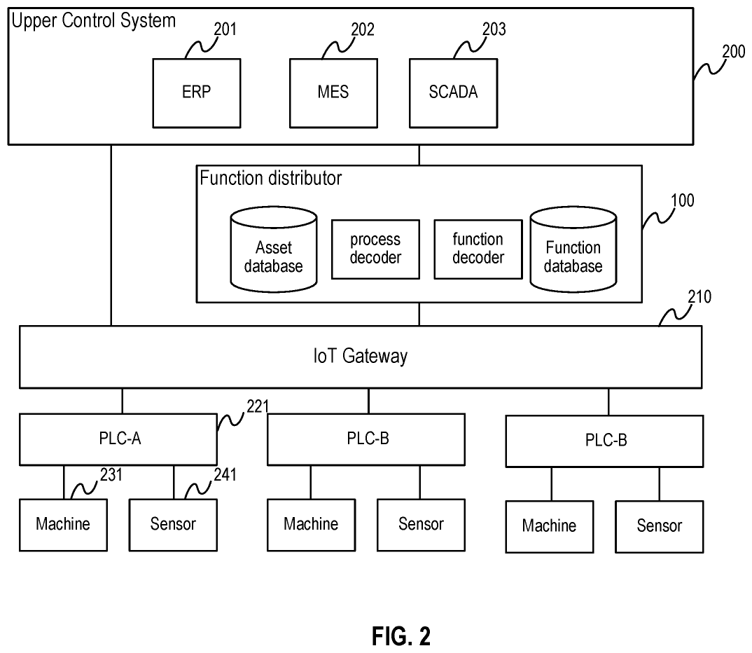

FIG. 2 illustrates an example of the overall configuration of a system, in accordance with an example implementation. ERP (Enterprise Resources Planning) 201, MES (Manufacturing Execution System) 202, SCADA (Supervisory Control And Data Acquisition) 203, and so on are included as upper control system 200. On the site, the system can involve manufacturing equipment (e.g., machine) 231, sensors 241 configured to monitor the equipment, Programmable Logic Controllers (PLCs) 221 to control the equipment, and IoT Gateway 210 to which multiple PLCs 221 are connected. I

The function distributor 100 in accordance with example implementations described herein is installed between the upper control system 200 and the site.

The setting of each of the production line, machine 231 and sensors 241 are transmitted to workers on site or the function distributor 100. The workers of the function distributor 100 change the setting of the production lines, machines and sensors accordingly.

The status of the manufactured products and status of the machines are acquired by PLC 221 and uploaded to the upper control system 200 via the IoT gateway 210. Such information is analyzed by the upper control system 200 and used to optimize production planning or production process.

In this example, the machine 231 and sensors 241 are connected via the PLC 221, but they may be directly connected. In this example, an IoT gateway 210 is installed, but it may be omitted or a similar function may be included inside the PLC 221. In addition, ERP 201, MES 202 and SCADA 203 are included in the upper control system 200, but these are not necessarily required.

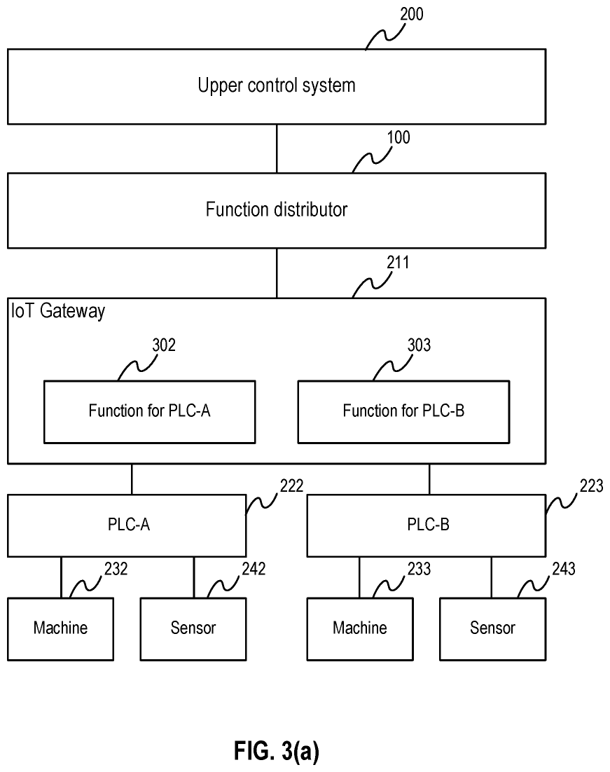

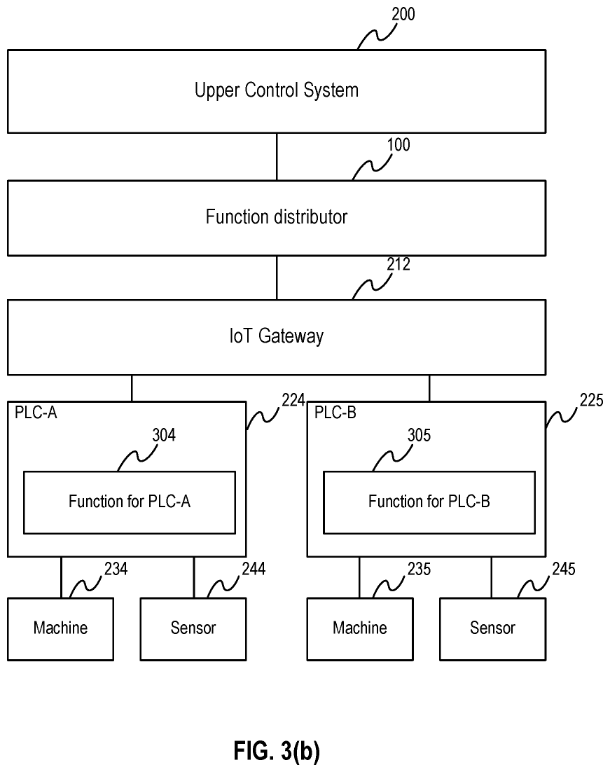

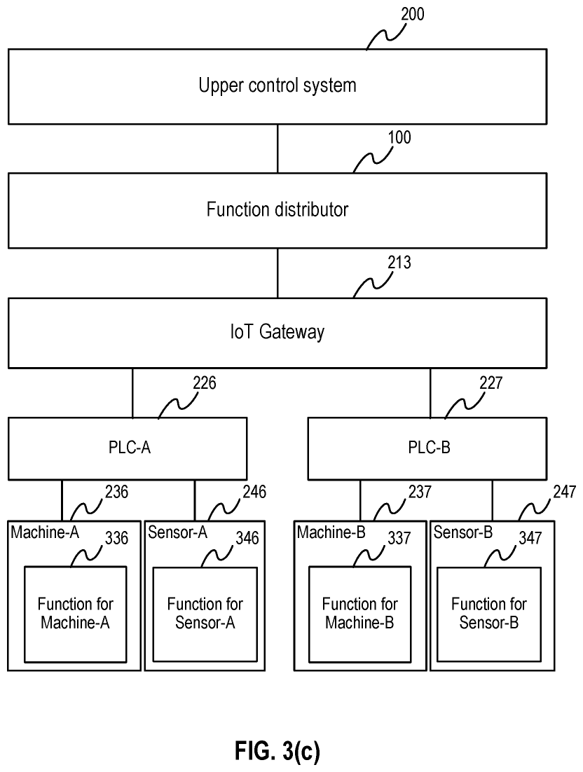

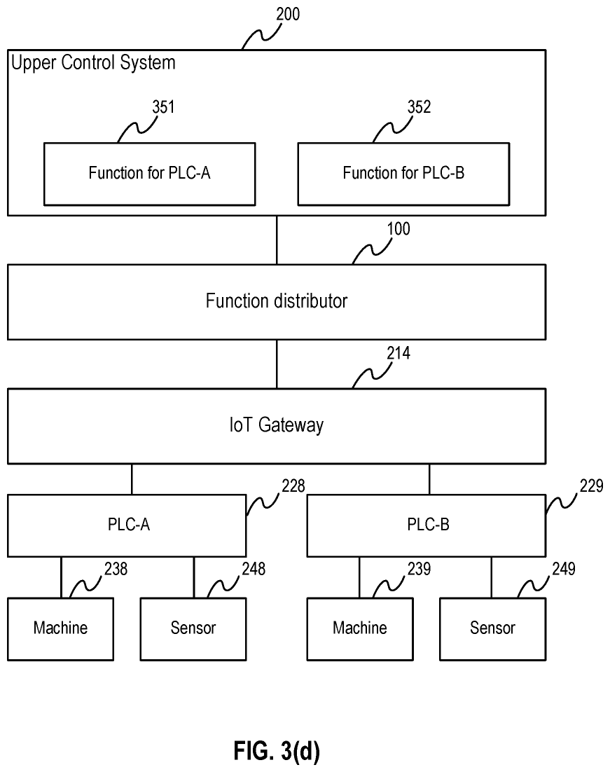

FIGS. 3(a) to 3(d) illustrate variations of locations where the generated function package software is installed, in accordance with an example implementation. In the example of FIG. 3(a), the function package software 302 and 303 are installed in the processing part inside the IoT gateway 211. Function package software 302 is the analysis function for PLC-A 222 managing machine 232 and sensor 242. Function package software 303 is the analysis function for PLC-B 223 managing machine 233 and sensor 243.

In the example of FIG. 3(b), the function package software 304 and 305 is installed in the arithmetic processing part inside the PLC through IoT gateway 212. In this example, function package software 304 is installed in the arithmetic processing portions of PLC-A 224 managing machine 234 and sensor 244. Function package software 305 is installed in the arithmetic processing portions of PLC-B 225 managing machine 235 and sensor 245. Function package software 304 is the analysis function for PLC-A 224, and function package software 305 is the analysis function for PLC-B 225.

In the example of FIG. 3(c), the function package software 336, 346, 337, and 347 are installed inside the processing units of the corresponding machine or sensor through the IoT gateway 213. In this example, the function package software 336 is installed on Machine-A 236 through PLC-A 226 and IoT gateway 213. The function package software 346 is installed on Sensor-A 246 through PLC-A 226 and IoT gateway 213. Similarly, the function package software 337 is installed on Machine-B 237 through PLC-B 227 and IoT gateway 213, and the function package software 347 is installed on Sensor-B 247 through PLC-A 227 and IoT gateway 213. Function package software 336 is the analysis function for Machine-A 236, function package software 337 is the analysis function for Machine-B 237, function package software 346 is the analysis function for Sensor-A 246, and function package software 347 is the analysis function for Sensor-B 247.

In the example of FIG. 3(d), the function package software 351 and 352 are installed inside the processing part of the upper control system 200. Function package software 351 is the analysis function for PLC-A 228 managing machine 238 and sensor 248, and function package software 352 is the analysis function for PLC-B 229 managing machine 239 and sensor 249. PLC-A 228 and PLC-B 229 are managed by upper control system 200 through IoT gateway 214.

In an example implementation of the system, suppose there is an increase in the error rate of certain products, for which the cause is an abnormal operation of a motor used in a plurality of processes. Further, assume that it is known that the state is not always abnormal, but occasionally becomes abnormal. Further, the motors used in the process have the same performance but are made by different vendors, and have different characteristics at the time of abnormal operation. Also, assume that it is known that certain vibration frequencies increase during abnormal operation.

In such a case, it is possible to identify the motor that is the cause of the failure by extracting the intensity of the specific frequency corresponding to the motor used in the target process.

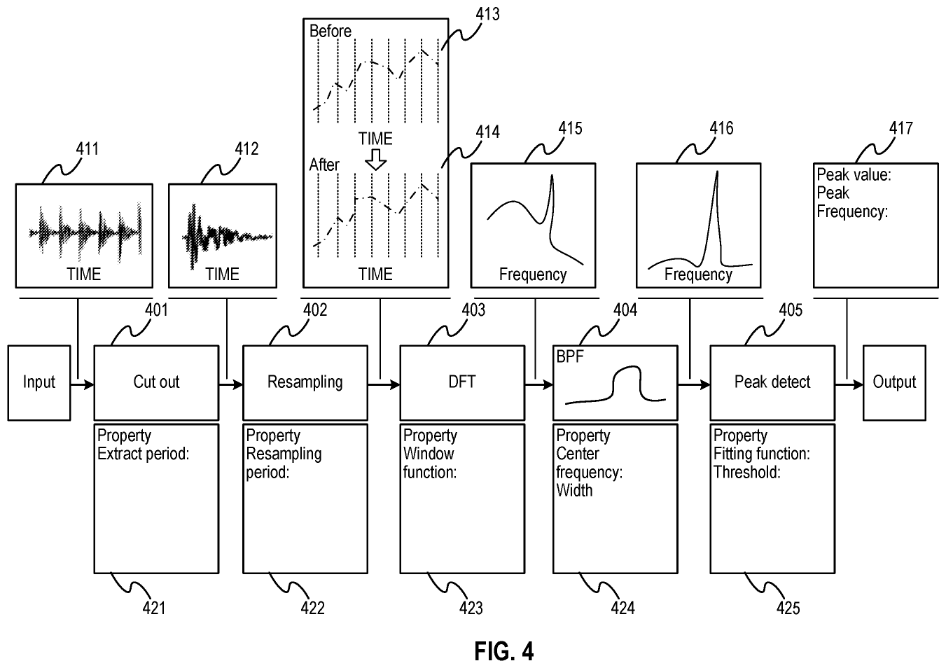

FIG. 4 illustrates an example identification process, in accordance with an example implementation. The data acquired by the sensor is continuous data of the time series as illustrated at 411. From the continuous data, only data having a characteristic period is extracted by a cut out process 401 configured to cut out the data for a necessary period as illustrated at 412.

Since the data is not necessarily sampled at equally intervals, the data is converted into data at equal intervals by a data resampling process 402 as shown at 413 and 414. After that, the data is transformed into frequency dependence by DFT (Discrete Fourier Transform) 403 as shown at 415. After that, through the BPF (Band Pass Filter) 404, only the necessary frequency domain is extracted as shown at 416. Further, through peak detection processing 405, the intensity of the target frequency is extracted as shown at 417. Each process has properties according to the content of the process.

In the cut out process, there is a period to be extracted 421. In resampling, the sampling period is that 422. In the DFT processing, the type of the window function is set 423. In BFP, a center frequency and a pass frequency width are set 424. In peak detect (e.g., obtaining the peak frequency of the sensor data), fitting function and threshold are set 425.

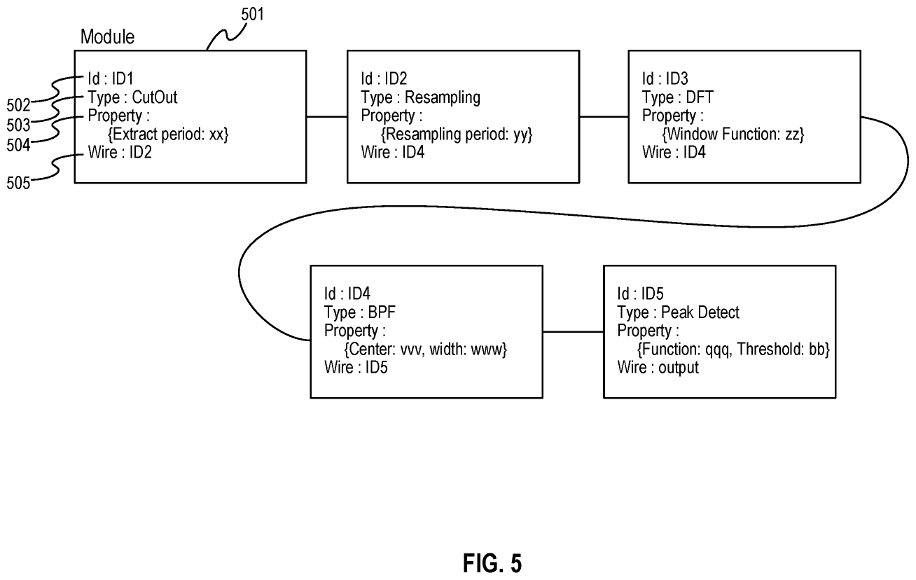

FIG. 5 illustrates an example of function package information in accordance with an example implementation. The example illustrated in FIG. 5 is the function package information described in a data format of JavaScript Object Notation (JSON). In FIG. 5, the information is described in the JSON data format, but the information may be described in another data format in accordance with the desired implementation. For example, the information may similarly be described in the Extensible Markup Language (XML) format, or an original data format may be defined.

Method repository 104 stores function methods which are represented by the function package information of FIG. 5. The function method is composed of a plurality of modules 501. Each module has an identifier (ID) 502, a type 503, a property 504, and wire 505. ID 502 is a name of target module that is unique in a function method. Type 503 is the primary function name which is provided by the primary function library 106. Property 504 is an array of setting values which are required by the primary function which defined by the type column. Wire 505 is the name of the output target modules.

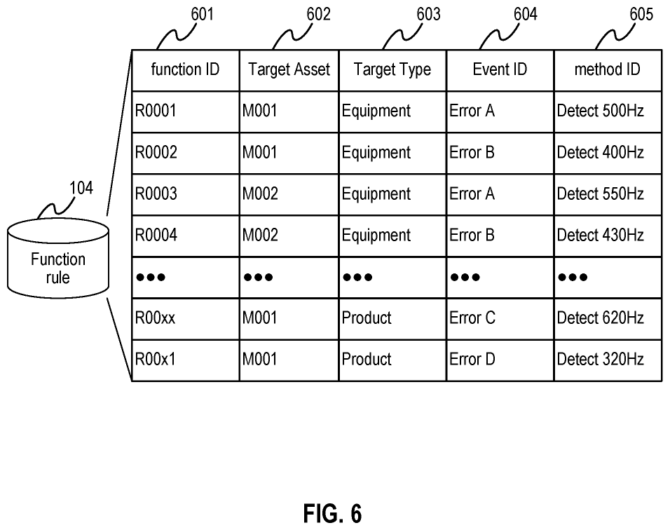

FIG. 6 is an explanatory table for showing an example of the function rule, in accordance with an example implementation. In the example of FIG. 6, the function rule 104 is represented as a table having a function ID 601, the target asset 602, target type 603, event ID 604 and method ID 605. The function ID 601 is an identifier of a function for classification. Target asset 602 is an identifier of the asset that outputs the original data for the calculation process. The target type 603 is an identifier of the source of the event. The event ID 604 is an identifier of the event to be observed. The method ID 605 is an identifier that defines an actual operation process.

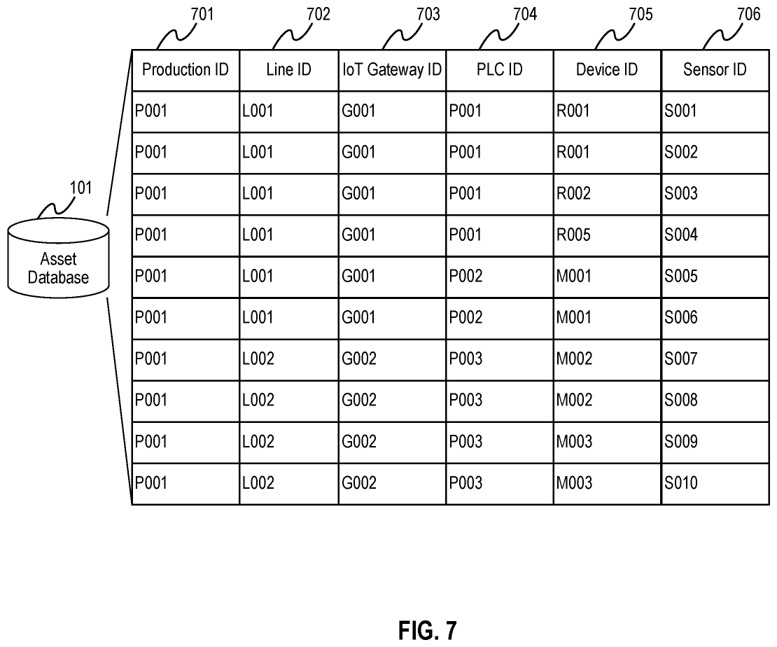

FIG. 7 is an explanatory table for showing an example of the asset configuration, in accordance with an example implementation. The asset database 101 is represented as a table having a Production ID 701, a Line ID 702, an IoT Gateway ID 703 a PLC ID 704, a Device ID 705, and a Sensor ID 706. The Production ID 701 is an identifier of the production process. The Line ID 702 is an identifier of the Line name. IoT Gateway ID 703 is an identifier of the IoT gateway. The PLC ID 704 is an identifier of the PLC. The Device ID 705 is an identifier of the device. The Sensor ID 706 is an identifier of a sensor. As sensors normally are disposed at particular locations, the sensor ID 706 can function as a location identifier to indicate its location on the factory floor. In another example implementation, the table of FIG. 7 can have a separate location identifier indicating the actual physical location (e.g., GPS coordinates) of the machine corresponding to device ID 705.

In the examples above, a table type database is illustrated, but such implementations can be adjusted to the desired implementation as needed (e.g., a graph type database may be used instead).

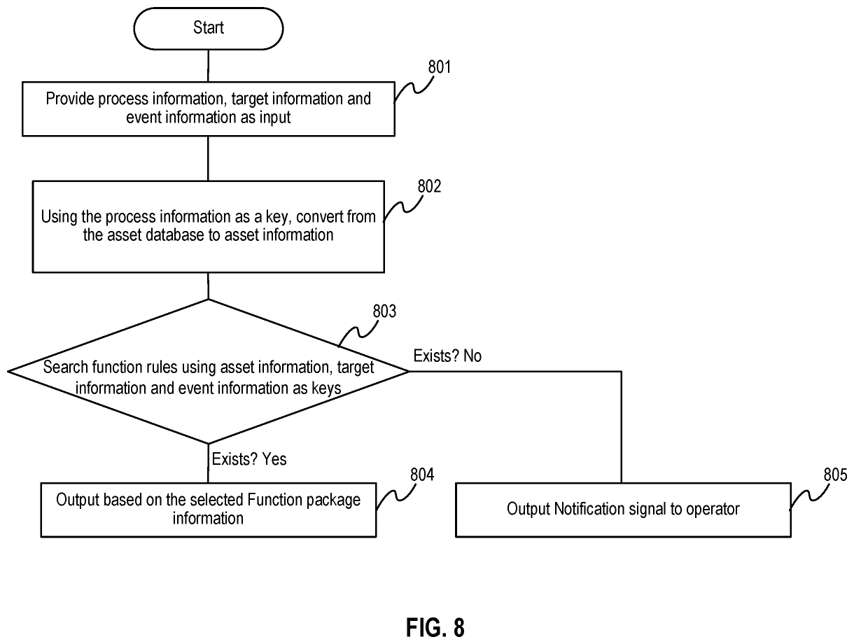

FIG. 8 illustrates an example of the flowchart of the system, in accordance with an example implementation. At 801, the process inputs the number of the target line and event information to be analyzed. At 802, the asset information is selected from the asset database using the process number of a line as a key. At 803, the function rule is searched by using asset information and event information as keys. If there is a function method corresponding to the input asset information and event information (Yes), the process proceeds to 804 to output the contents. Otherwise, if there is no function method corresponding to the input asset information and event information (No), the process proceeds to 805 to send an alarm notification to the operator 805.

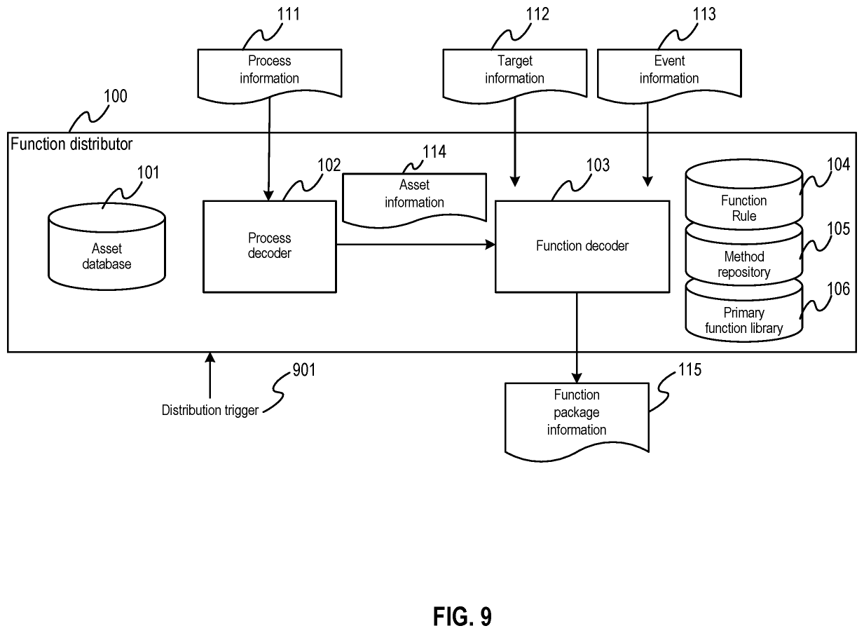

FIG. 9 illustrates an example of a block diagram for adjusting the distribution timing of a program, in accordance with an example implementation. The distribution timing can be adjusted according to the operation state of the target device. The trigger signal 901 is input to the function distributor 100, and the function distributor 100 outputs function package information 115 in synchronization with trigger signal 901.

The trigger signal 901 is used as a distribution trigger, as there can be many machines in a line for an IoT system. In such systems, it is difficult to change the function package while the factory floor is running. Therefore, the distribution trigger will control the timing to installing the functions in the IoT devices. The distribution trigger will synchronize the package install to the IoT devices.

In an example implementation, the input for the trigger signal 901 or the parameters of the distribution trigger can be provided by the IT operator of the upper control system 200 and provided through a user interface, or can be automated in accordance with the desired implementation.

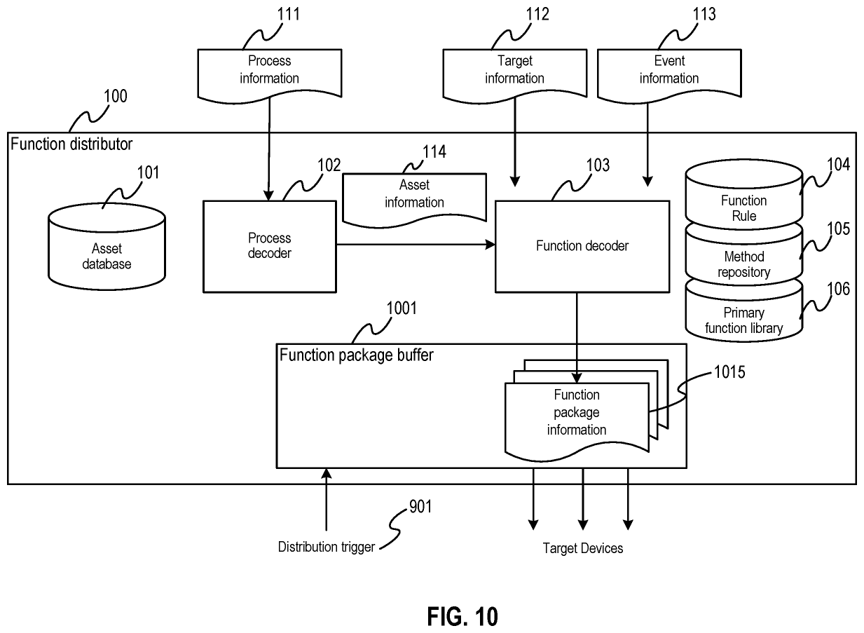

FIG. 10 illustrates an example of a block diagram for adjusting the distribution timing of a program, in accordance with an example implementation. The adjustment of the distribution timing of a program is conducted according to the operation state of the target device. When there are a plurality of devices that need to distribute programs at the same time, the distribution timing may need to be adjusted.

The function package buffer 1001 temporarily stores the function package information 1015 which are output from the function decoder 103. Further, the function package buffer 1001 distributes the function package information 1015 to each of the target devices in synchronization with the distribution trigger 901.

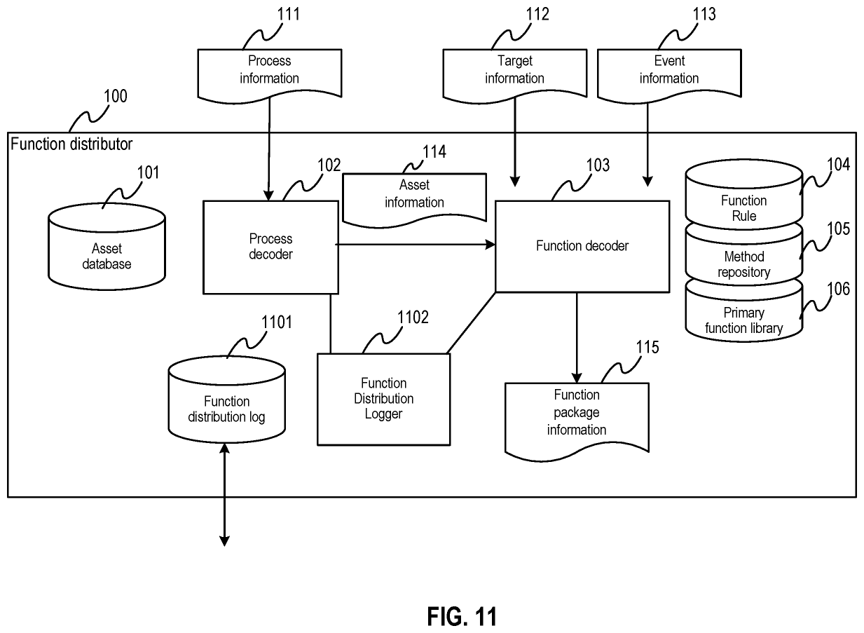

FIG. 11 illustrates an example of logging system for function distributor system, in accordance with an example implementation. The function distribution logger 1102 is connected to process decoder 102 and function decoder 103, stores information related to the generation and distribution of the target function package information 115 in the function distribution log 1101 with timestamp. The function distribution log 1101 is accessible from outside of this system, such as the upper control system.

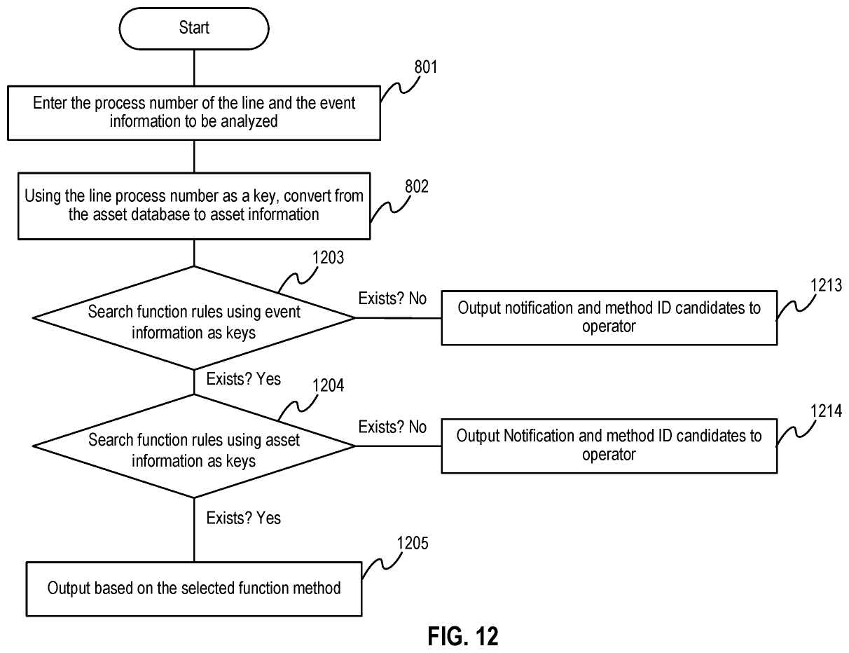

FIG. 12 illustrates an example of the processing flow when data of a target device or a target event does not exist in the function rule, in accordance with an example implementation. First, the process number of the target line and event information to be analyzed are input in the same manner as FIG. 8. Similar to FIG. 8, the asset information is selected from the asset database using the process number of a line as a key.

At 1203, a function rule is searched by using event information such as event ID as the key. If there is no target event ID in function rule (No), the process proceeds to 1213 so that a notification and selected method ID candidates are sent to the operator.

If the target event exists (Yes), then the process proceeds to 1204 to search the function rules by using the asset information as the keys. If the target device does not exist in the function rule (No), the process proceeds to 1214 to transmit a notification and selected method ID candidates having the same device type and vendor to the operator. If an existing method ID is selected by the operator, the new method ID and device name are recorded to the function rule.

Otherwise (Yes), the process proceeds to 1205 to provide output based on the selected function method.

Further, in this example, the notification and selection to the operator are shown, but a machine learning algorithm may also be used in accordance with the desired implementation. In such an example implementation, a machine learning algorithm can be configured to deploy a model that statistically associates the result of the selection of the method ID by a person with information on the device/asset and event information necessary for the selection.

Through the example implementations described herein, there can be support for different pre-processing and alarm thresholds depending on the product. Further, the example implementations can apply the primary processing function examined and created on the test line to a line with a different PLC/main machine.

Further, when an error occurs, the relevant or related processes are centrally monitored, and analysis and countermeasures are advanced through the example implementations described herein.

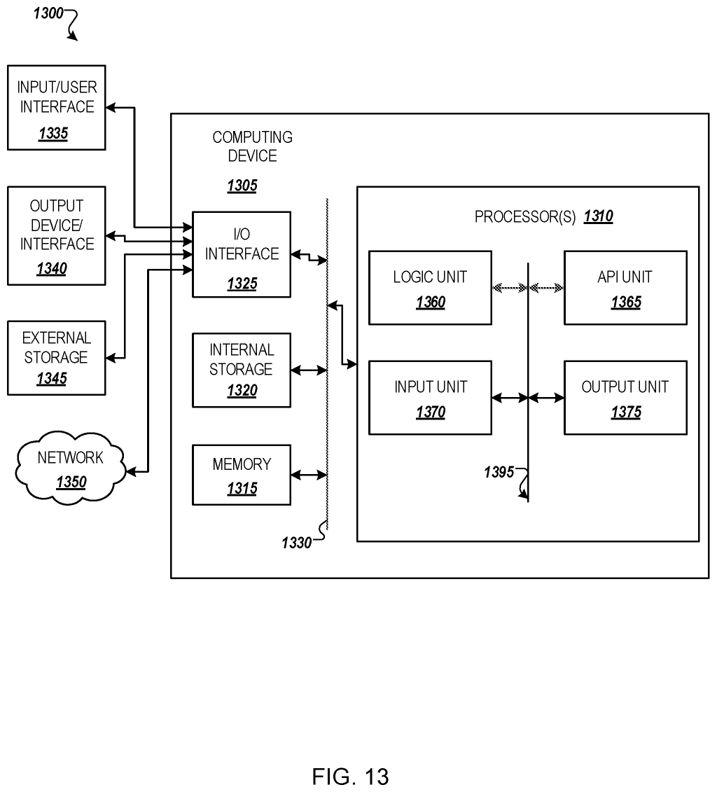

FIG. 13 illustrates an example computing environment with an example computer device suitable for use in some example implementations, such as a function distributor to manage a factory system having a plurality of assets, the plurality of assets having a plurality of programmable logic controllers (PLCs), a plurality of machines managed by the plurality of PLCs, and a plurality of sensors associated with the plurality of machines as described herein. Computer device 1305 in computing environment 1300 can include one or more processing units, cores, or processors 1310, memory 1315 (e.g., RAM, ROM, and/or the like), internal storage 1320 (e.g., magnetic, optical, solid state storage, and/or organic), and/or 10 interface 1325, any of which can be coupled on a communication mechanism or bus 1330 for communicating information or embedded in the computer device 1305. IO interface 1325 is also configured to receive images from cameras or provide images to projectors or displays, depending on the desired implementation.

Computer device 1305 can be communicatively coupled to input/user interface 1335 and output device/interface 1340. Either one or both of input/user interface 1335 and output device/interface 1340 can be a wired or wireless interface and can be detachable. Input/user interface 1335 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1340 may include a display, television, monitor, printer, speaker, braille, or the like. In some example implementations, input/user interface 1335 and output device/interface 1340 can be embedded with or physically coupled to the computer device 1305. In other example implementations, other computer devices may function as or provide the functions of input/user interface 1335 and output device/interface 1340 for a computer device 1305.

Examples of computer device 1305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1305 can be communicatively coupled (e.g., via 10 interface 1325) to external storage 1345 and network 1350 for communicating with any number of networked components, devices, and systems, including one or more computer devices of the same or different configuration. Computer device 1305 or any connected computer device can be functioning as, providing services of, or referred to as a server, client, thin server, general machine, special-purpose machine, or another label.

IO interface 1325 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1300. Network 1350 can be any network or combination of networks (e.g., the Internet, local area network, wide area network, a telephonic network, a cellular network, satellite network, and the like).

Computer device 1305 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1310 can execute under any operating system (OS) (not shown), in a native or virtual environment. One or more applications can be deployed that include logic unit 1360, application programming interface (API) unit 1365, input unit 1370, output unit 1375, and inter-unit communication mechanism 1395 for the different units to communicate with each other, with the OS, and with other applications (not shown). The described units and elements can be varied in design, function, configuration, or implementation and are not limited to the descriptions provided. Processor(s) 1310 can be in the form of hardware processors such as central processing units (CPUs) or in a combination of hardware and software units.

In some example implementations, when information or an execution instruction is received by API unit 1365, it may be communicated to one or more other units (e.g., logic unit 1360, input unit 1370, output unit 1375). In some instances, logic unit 1360 may be configured to control the information flow among the units and direct the services provided by API unit 1365, input unit 1370, output unit 1375, in some example implementations described above. For example, the flow of one or more processes or implementations may be controlled by logic unit 1360 alone or in conjunction with API unit 1365. The input unit 1370 may be configured to obtain input for the calculations described in the example implementations, and the output unit 1375 may be configured to provide output based on the calculations described in example implementations.

Memory 1315 can be configured to management information such as process information, event information, and so on as illustrated in FIGS. 4-7 and 11.

Processor(s) 1310 can be configured to extract, from process information received from the factory system, a line identifier, a process identifier, and a location identifier, to select a target asset from the plurality of assets corresponding to the line identifier, the process identifier, and the location identifier, from an asset database managing the plurality of assets; determine, from event information received from the system, one or more events associated with the target asset; select a function method to be deployed to the target asset based on an event of the one or more events; and install, for the target asset, a function package software corresponding to the target asset and the function method as illustrated in FIGS. 1 and 8.

Depending on the desired implementation, the location identifier is one or more of a sensor identifier corresponding to a sensor from the plurality of sensors and a physical location of the factory system as illustrated in FIG. 7.

Processor(s) 1310 can be configured to install, on the target asset, the function package software corresponding to the target asset and the function method in response to a trigger signal set to a distribution timing based on the state of the target asset as illustrated in FIG. 9.

Depending on the desired implementation, memory 1315 can be configured to manage logging information associated with generating and installing the function package software as illustrated in FIG. 11.

Processor(s) 1310 can be configured to select the function method to be deployed to the target asset based on the event of the one or more events by determining function methods associated with the one or more events associated with the target asset; determining ones of the function methods associated with the target asset; receiving a selection of the event; and selecting the function method associated with the event from the ones of the function methods as illustrated in FIG. 12. Depending on the desired implementation, processor(s) 1310 can be configured to select the function method associated with the event from the ones of the function method is conducted through use of a machine learning algorithm configured to statistically associate selections of function methods with the target asset and event as illustrated in FIGS. 1 and 12.

Depending on the desired implementation, the function package software can be installed on an Internet of Things (IoT) gateway configured to control the plurality of PLCs, wherein the function package software is configured to control functions for the plurality of PLCs as illustrated in FIG. 3(a).

Depending on the desired implementation, the function package software can be installed on the plurality of PLCs, wherein the function package software is configured to control functions for the plurality of PLCs as illustrated in FIG. 3(b).

Depending on the desired implementation, the function package software can be installed on the plurality of machines and the plurality of sensors, wherein the function package software is configured to control functions for the plurality of machines and the plurality of sensors as illustrated in FIG. 3(c).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for a factory system comprising a plurality of assets, the plurality of assets comprising a plurality of programmable logic controllers (PLCs), a plurality of machines managed by the plurality of PLCs, and a plurality of sensors associated with the plurality of machines, the method comprising:
extracting, from process information received from the factory system, a line identifier, a process identifier, and a location identifier, to select a target asset from the plurality of assets corresponding to the line identifier, the process identifier, and the location identifier, from an asset database managing the plurality of assets;
determining, from event information received from the system, one or more events associated with the target asset;
selecting a function method to be deployed to the target asset based on an event of the one or more events; and
installing, for the target asset, a function package software corresponding to the target asset and the function method.

2. The method of claim 1, wherein the location identifier is one or more of a sensor identifier corresponding to a sensor from the plurality of sensors and a physical location of the factory system.

3. The method of claim 1, wherein the installing, on the target asset, the function package software corresponding to the target asset and the function method is conducted in response to a trigger signal set to a distribution timing based on the state of the target asset.

4. The method of claim 1, further comprising logging information associated with generating and installing the function package software.

5. The method of claim 1, wherein the selecting the function method to be deployed to the target asset based on the event of the one or more events comprises:
determining function methods associated with the one or more events associated with the target asset;
determining ones of the function methods associated with the target asset;
receiving a selection of the event; and
selecting the function method associated with the event from the ones of the function methods.

6. The method of claim 5, wherein the selecting the function method associated with the event from the ones of the function method is conducted through a machine learning algorithm configured to statistically associate selections of function methods with the target asset and event.

7. The method of claim 1, wherein the function package software is installed on an Internet of Things (IoT) gateway configured to control the plurality of PLCs, wherein the function package software is configured to control functions for the plurality of PLCs.

8. The method of claim 1, wherein the function package software is installed on the plurality of PLCs, wherein the function package software is configured to control functions for the plurality of PLCs.

9. The method of claim 1, wherein the function package software is installed on the plurality of machines and the plurality of sensors, wherein the function package software is configured to control functions for the plurality of machines and the plurality of sensors.

10. A non-transitory computer readable medium, storing instructions for a factory system comprising a plurality of assets, the plurality of assets comprising a plurality of programmable logic controllers (PLCs), a plurality of machines managed by the plurality of PLCs, and a plurality of sensors associated with the plurality of machines, the instructions comprising:
extracting, from process information received from the factory system, a line identifier, a process identifier, and a location identifier, to select a target asset from the plurality of assets corresponding to the line identifier, the process identifier, and the location identifier, from an asset database managing the plurality of assets;
determining, from event information received from the system, one or more events associated with the target asset;
selecting a function method to be deployed to the target asset based on an event of the one or more events; and
installing, for the target asset, a function package software corresponding to the target asset and the function method.

11. The non-transitory computer readable medium of claim 10, wherein the location identifier is one or more of a sensor identifier corresponding to a sensor from the plurality of sensors and a physical location of the factory system.

12. The non-transitory computer readable medium of claim 10, wherein the installing, on the target asset, the function package software corresponding to the target asset and the function method is conducted in response to a trigger signal set to a distribution timing based on the state of the target asset.

13. The non-transitory computer readable medium of claim 10, the instructions further comprising logging information associated with generating and installing the function package software.

14. The non-transitory computer readable medium of claim 10, wherein the selecting the function method to be deployed to the target asset based on the event of the one or more events comprises:
determining function methods associated with the one or more events associated with the target asset;
determining ones of the function methods associated with the target asset;
receiving a selection of the event; and
selecting the function method associated with the event from the ones of the function methods.

15. The non-transitory computer readable medium of claim 14, wherein the selecting the function method associated with the event from the ones of the function method is conducted through a machine learning algorithm configured to statistically associate selections of function methods with the target asset and event.

16. The non-transitory computer readable medium of claim 10, wherein the function package software is installed on an Internet of Things (IoT) gateway configured to control the plurality of PLCs, wherein the function package software is configured to control functions for the plurality of PLCs.

17. The non-transitory computer readable medium of claim 10, wherein the function package software is installed on the plurality of PLCs, wherein the function package software is configured to control functions for the plurality of PLCs.

18. The non-transitory computer readable medium of claim 10, wherein the function package software is installed on the plurality of machines and the plurality of sensors, wherein the function package software is configured to control functions for the plurality of machines and the plurality of sensors.

19. An apparatus, configured to manage a factory system comprising a plurality of assets, the plurality of assets comprising a plurality of programmable logic controllers (PLCs), a plurality of machines managed by the plurality of PLCs, and a plurality of sensors associated with the plurality of machines, the apparatus comprising:
a processor, configured to:
extract, from process information received from the factory system, a line identifier, a process identifier, and a location identifier, to select a target asset from the plurality of assets corresponding to the line identifier, the process identifier, and the location identifier, from an asset database managing the plurality of assets;
determine, from event information received from the system, one or more events associated with the target asset;
select a function method to be deployed to the target asset based on an event of the one or more events; and
install, for the target asset, a function package software corresponding to the target asset and the function method.
